(19) United States
(12) Patent Application Publication
(10) Pub. No.: US 2022/0123925 A1
(43) Pub. Date: Apr. 21, 2022

(54) SECURITY ENHANCED BLOCKCHAIN SYSTEM BASED ON DATA DOUBLE ENCRYPTION AND DECRYPTION

(71) Applicant: BIGSTER INC., Seoul (KR)

(72) Inventor: Hyun Jong LEE, Seoul (KR)

(73) Assignee: BIGSTER INC., Seoul (KR)

(21) Appl. No.: 17/421,130

(22) PCT Filed: Nov. 11, 2019
(86) PCT No.: PCT/KR2019/015244

§ 371 Date: Jul. 7, 2021

(51) Int. Cl. H04L 9/08; H04L 9/32; G06F 21/62

(52) U.S. Cl. CPC H04L 9/0825; H04L 2209/38; G06F 21/6227; H04L 9/3247

(57) ABSTRACT

Disclosed herein are a method and apparatus for blockchain-based data security, the method being performed by a data security apparatus. The data security method indudes: a primary encryption step of converting original data, previously stored in an original data storage apparatus, into primary encrypted data by encrypting the original data; a secondary encryption step of converting the primary encrypted data into secondary encrypted data by encrypting the primary encrypted data; and a blockchain transmission step of transmitting the secondary encrypted data to a node constituting a part of a blockchain network so that the secondary encrypted data is stored in the ledger of a blockchain.

### TECHNICAL FIELD

The present disclosure relates to a data security method to which blockchain technology is applied.

### BACKGROUND ART

In general, blockchain technology is well known as the technology that can ensure the immutability and transparency of the data recorded in a blockchain because all transaction details can be recorded in the blockchain, enables anyone to monitor all transaction details, and can make the manipulation of transaction details impossible. Korean Patent Application Publication No. 10-2019-0019004 discloses a technology for a blockchain-based trading system.

Recently, the European Union has put the General Data Protection Regulation (GDPR), which is a new privacy regulation, in force. As for the personally identifiable information (PII) of the citizens of European Union member states, the GDPR provides transparency in the use of the information, and gives the residents of the EU the right to request a restriction on the use of personal data or to request the deletion of all personal data. However, there is a possibility that blockchain technology may violate the revised GDPR regulation, and there are concerns that companies may be reluctant to perform blockchain-based projects.

In other words, in the GDPR, the rights of data subjects have been strengthened. Accordingly, when a data subject requests the right to be forgotten, corresponding personal information must be deleted. In contrast, due to the nature of current blockchain technology, data registered once cannot be deleted, and thus there is a risk that the revised GDPR will conflict with the blockchain technology.

Therefore, there is a need for the development of a technology that does not violate the GDPR that aims to ensure the basic rights of individuals while making use of the advantages of a blockchain.

Meanwhile, in recent years, a series of processes in which an individual who is an information subject actively manages and controls his or her information and actively utilizes it in personal life in a range from credit management through asset management up to health management is called MyData. As interest in the MyData industry (personal information utilization support business), which is an industry that professionally supports the efficient personal information management and utilization of individuals, is on the rise, there is a need for a technology that is optimized for the MyData service that stores or distributes sensitive data such as personal information.

### DISCLOSURE

### Technical Problem

The technical spirit of the present disclosure is intended to overcome the above-described problems, and an object of the present disclosure is to provide a technology that blocks access to data so that the content of the data cannot be checked without deleting the data stored in a blockchain.

Furthermore, another object of the technical spirit of the present disclosure is to provide a technology in which the security of data stored in a blockchain is improved.

In addition, another object of the technical spirit of the present disclosure is to provide a technology that can be applied to the MyData service that handles sensitive and security-requiring data such as personal information.

The objects of the present invention are not limited to the above-described objects, and other objects that are not described will be clearly understood by those of ordinary skill in the art from the following description.

### Technical Solution

In order to accomplish the above objects, according to an aspect of the present invention, there is provided a method for blockchain-based data security, the method being performed by a data security apparatus, the method induding: a primary encryption step of converting original data, previously stored in an original data storage apparatus, into primary encrypted data by encrypting the original data; a secondary encryption step of converting the primary encrypted data into secondary encrypted data by encrypting the primary encrypted data; and a blockchain transmission step of transmitting the secondary encrypted data to a node constituting a part of a blockchain network so that the secondary encrypted data is stored in the ledger of a blockchain.

In addition, the method may further include a key generation step of generating an encryption key used to encrypt the primary encrypted data into the secondary encrypted data and generating a decryption key used to decrypt the secondary encrypted data into the primary encrypted data.

Furthermore, the method may further include a first mapping table generation step of generating a first mapping table by mapping the original data to the primary encrypted data as a pair.

Additionally, the method may further indude a second mapping table generation step of generating a second mapping table by mapping the secondary encrypted data to the decryption key as a pair.

In order to accomplish the above objects, according to another aspect of the present invention, there is provided a method for blockchain-based data security, the method being performed by a data security apparatus including a first mapping table generated by mapping primary encrypted data obtained by encrypting original data previously stored in an original data storage apparatus to the original data as a pair, and a second mapping table generated by mapping secondary encrypted data obtained by encrypting the primary encrypted data to a decryption key used to decrypt the secondary encrypted data as a pair, the method including: a second mapping table checking step of checking whether data matching secondary encrypted data previously stored in a ledger of a blockchain is present in the second mapping table; a key extraction step of extracting a decryption key mapped to the data as a pair from the second mapping table; and a data decryption step of decrypting the data into primary encrypted data using the extracted decryption key.

Furthermore, the method may further include a first mapping table checking step of checking whether a value matching the decrypted, primary encrypted data is present in the first mapping table.

In addition, the method may further indude an original data extraction step of extracting original data mapped to the value as a pair from the first mapping table.

In order to accomplish the above objects, according to still another aspect of the present invention, there is provided an apparatus for blockchain-based data security, the apparatus including: a first encryption unit configured to encrypt original data previously stored in an original data storage apparatus; a first mapping table generation unit configured to generate a first mapping table by mapping primary encrypted data, generated by the first encryption unit, to the original data as a pair; an encryption key generation unit configured to generate an encryption key used to encrypt the primary encrypted data into secondary encrypted data; a decryption key generation unit configured to generate a decryption key used to decrypt the secondary encrypted data into the primary encrypted data; a second encryption unit configured to encrypt the primary encrypted data into the secondary encrypted data using the encryption key; a second mapping table generation unit configured to generate a second mapping table by mapping the secondary encrypted data, generated by the second encryption unit, to the decryption key as a pair; and a communication unit configured to transmit the secondary encrypted data to a node constituting a part of a blockchain network so that the secondary encrypted data is stored in a ledger of a blockchain.

In addition, the apparatus may further include a control unit configured to control the generation of the first mapping table and the second mapping table and a decryption unit configured to decrypt the secondary encrypted data into the primary encrypted data using the decryption key, and the control unit may perform control so that it is checked whether data matching the secondary encrypted data previously stored in the ledger of the blockchain is present in the second mapping table, the data is decrypted into primary encrypted data using a decryption key mapped to the data as a pair if the data is present, and original data mapped to a value matching the decrypted primary encrypted data as a pair is extracted from the first mapping table.

In order to accomplish the above objects, according to still another aspect of the present invention, there is provided a computer-readable storage medium having stored thereon a program for performing the above-described features and method.

The above-described technical solutions are merely exemplary, and should not be construed as limiting the present invention. In addition to the above-described exemplary embodiments, there may be additional embodiments described in the drawings and detailed description of the invention.

### Advantageous Effects

As described above, according to the various embodiments of the present invention, original data is encrypted twice and secondary encrypted data is stored in the ledger of a blockchain, so that the effect of ensuring the security of stored data is achieved even when data related to personal information is stored in the blockchain.

In addition, according to the various embodiments of the present invention, original data and primary encrypted data mapped to each other as a pair in a primary mapping table are deleted, or secondary encrypted data and a decryption key mapped to each other as a pair in a secondary mapping table are deleted, so that access to the original data through the secondary encrypted data may be blocked without directly deleting or changing the secondary encrypted data stored in a blockchain.

Effects according to the various embodiments of the present invention are not limited to the above-described effects, and other effects that are not described will be clearly understood by those of ordinary skill in the art from the description of the claims.

### DESCRIPTION OF DRAWINGS

FIG. 1 is a conceptual diagram schematically showing a relationship in which a data processing apparatus according to an embodiment of the present invention is connected to an original data storage apparatus and a blockchain node;

FIG. 2 is a block diagram schematically showing the individual components of a data security apparatus according to an embodiment of the present invention;

FIG. 3 is a conceptual diagram schematically showing a series of processes in which in an embodiment of the present invention, data matching original data present in the original data storage apparatus is encrypted into secondary encrypted data through primary and secondary encryption and the secondary encrypted data is stored in the ledger of a blockchain and a process in which the secondary encrypted data is decrypted into primary encrypted data;

FIG. 4 is a flowchart schematically showing a data security method according to an embodiment of the present invention, and is a flowchart illustrating a process in which original data is encrypted and transmitted to a blockchain node; and

FIG. 5 is a flowchart schematically showing a data security method according to another embodiment of the present invention, and is a flowchart schematically showing a method of decrypting secondary encrypted data matching secondary encrypted data previously stored in the ledger of a blockchain and checking original data.

### MODE FOR INVENTION

Preferred embodiments of the present invention will be described in more detail with reference to the accompanying drawings, but technical parts that are already well known will be omitted or abridged for brevity of description.

In the following embodiments, terms such as first and second are not used in limiting senses, but are each used for the purpose of distinguishing one component from another component.

It should be noted that in this specification, a references to “a single” or “one” embodiment of the present invention are not necessarily to the same embodiment and mean at least one.

In the following embodiments, a singular expression includes a plural expression unless the context clearly dictates otherwise.

In the following embodiments, terms such as include or have means that one or more features or components described in the specification are present, and do not preclude the possibility that one or more other features or components may be added. In other words, when a part is described as “including” a predetermined component in the specification, it means that one or more other components may be further included rather than excluding one or more other components unless otherwise stated.

The term ‘part’ or ‘portion’ used herein refers to a unit that processes at least one function or operation, and may be implemented as software, hardware, or a combination of hardware and software. According to embodiments, a plurality of ‘˜ units’ may be implemented as a single unit, or a single ‘˜ unit’ may include a plurality of components.

When an embodiment may be implemented in a different manner, a specific process sequence may be performed in a sequence different from a described one. For example, two processes described in succession may be performed substantially simultaneously, or may be performed in a sequence opposite to a described sequence. In other words, individual steps of the method described herein may be appropriately performed in any sequence unless otherwise stated in the specification or dearly contradicted by context.

In the following embodiments, when a part is described as being “connected” with another part, it includes not only the case where the former part is “directly connected” with the latter part but also the case where the former part is “indirectly connected” with the latter part with another member interposed therebetween.

In the drawings, components may be exaggerated or reduced in size for ease of description. For example, the size and thickness of each component shown in the drawings and each component shown in the drawings are arbitrarily shown for ease of description, and thus the present invention is not necessarily limited to what is shown.

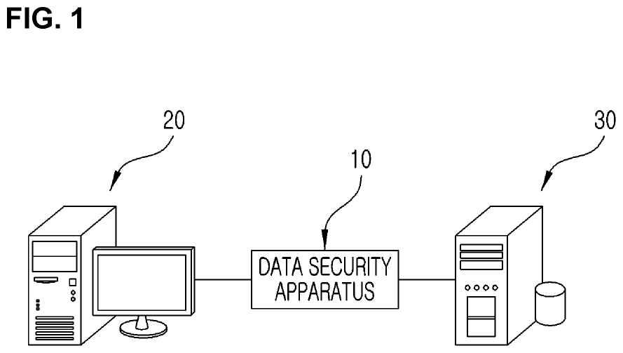

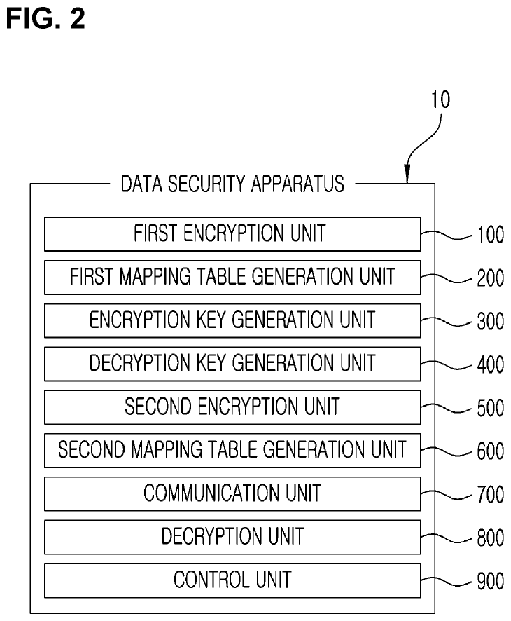

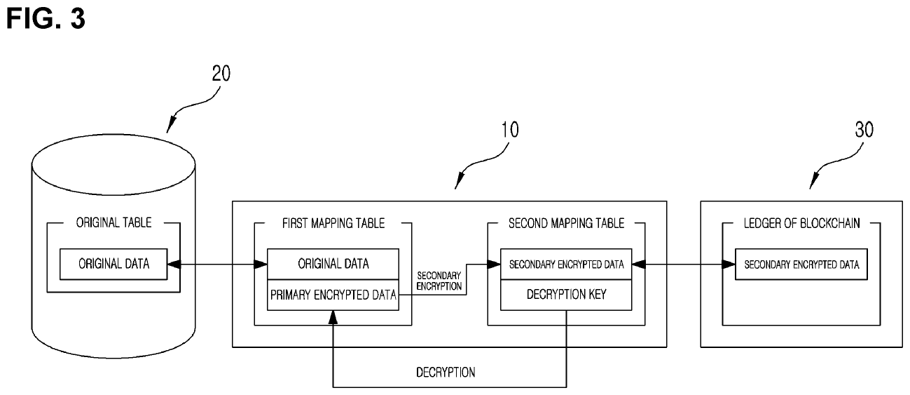

FIG. 1 is a conceptual diagram schematically showing a relationship in which a data processing apparatus according to an embodiment of the present invention is connected to an original data storage apparatus and a blockchain node, FIG. 2 is a block diagram schematically showing the individual components of a data security apparatus according to an embodiment of the present invention, and FIG. 3 is a conceptual diagram schematically showing a series of processes in which in an embodiment of the present invention, data matching original data present in the original data storage apparatus is encrypted into secondary encrypted data through primary and secondary encryption and the secondary encrypted data is stored in the ledger of a blockchain and a process in which the secondary encrypted data is decrypted into primary encrypted data.

Referring to FIGS. 1 to 3, a data security apparatus 10 according to an embodiment may include a first encryption unit 100, a first mapping table generation unit 200, an encryption key generation unit 300, a decryption key generation unit 400, a second encryption unit 500, a second mapping table generation unit 600, a communication unit 700, a decryption unit 800, and a control unit 900.

However, not all of the illustrated components are essential components. The data security apparatus 10 may be implemented by a number of components larger than the number of illustrated components, and may be implemented by a number of components smaller than the number of illustrated components.

The configuration of the data security apparatus 10 shown in FIGS. 1 to 3 is an embodiment, and each component of the data security apparatus 10 is integrated, added or omitted according to the specifications of the implemented data security apparatus 10. In other words, if necessary, two or more components may be combined into one component, or one component may be subdivided into and configured as two or more components.

Furthermore, functions performed in the respective components of the data security apparatus 10 are intended to describe embodiments, and the specific operations or devices thereof do not limit the scope of the present invention. The data security apparatus 10 according to an embodiment may be applied as an apparatus capable of encrypting or decrypting data or capable of both encryption and decryption.

In an embodiment, the first encryption unit 100 may encrypt original data, previously stored in an original data storage apparatus 20, into primary encrypted data. In one specific embodiment, the first encryption unit 100 may encrypt the original data using an encryption algorithm (e.g., SHA-256, MD5, or the like).

Furthermore, in an embodiment, the first mapping table generation unit 200 may generate a first mapping table by mapping the primary encrypted data, generated by the first encryption unit 100, to the original data as a pair.

In an embodiment, the encryption key generation unit 300 may generate an encryption key used to encrypt the primary encrypted data into secondary encrypted data, and the decryption key generation unit 400 may generate a decryption key used to decrypt the secondary encrypted data into the primary encrypted data. Known key generation algorithms may be applied as the algorithm by which the encryption key is generated by the encryption key generation unit 300 and the algorithm by which the decryption key is generated by the decryption key generation unit 400, and thus detailed descriptions thereof will be omitted.

In an embodiment, the second encryption unit 500 may encrypt the primary encrypted data into the secondary encrypted data through the encryption key. The second encryption unit 500 may perform encryption using the encryption key, but may re-encrypt the primary encrypted data into the secondary encrypted data using various known encryption algorithms.

The second mapping table generation unit 600 may generate a second mapping table by mapping the secondary encrypted data, generated by the second encryption unit 500, to the decryption key as a pair.

In other words, the secondary encrypted data and the decryption key mapped to each other by the second mapping table generation unit 600 have a close relationship with each other. The decryption key may be used to convert the secondary encrypted data, mapped to it, into the primary encrypted data.

In an embodiment, the communication unit 700 may transmit the secondary encrypted data to at least one node 30 constituting a part of a blockchain network so that the secondary encrypted data is stored in the ledger of a blockchain.

In this case, the blockchain network may include a plurality of nodes 30, and computing apparatuses connected to the blockchain distributed network may be applied as the nodes 30. Furthermore, each of the nodes 30 may include a memory module configured to store the ledger of the blockchain, and the memory module may be applied as a blockchain database configured to store all or part of the blocks of the overall blockchain.

Computing apparatuses, such as personal computers (PCs), smartphones, personal digital assistants (PDAs) and/or tablet PCs, each including a central processing unit, a memory device, and an input/output means may be applied as the above-described computing apparatuses. In addition to these, other known types of computing apparatuses may also be applied.

In an embodiment, the decryption unit 800 may decrypt the secondary encrypted data into the primary encrypted data through the decryption key. When the secondary encrypted data is decrypted into the primary encrypted data by using the decryption key, the decryption unit 800 may use various types of disclosed decryption algorithms, so that a detailed description of the decryption algorithm will be omitted.

Furthermore, in an embodiment, the control unit 900 may control the overall operation of the data security apparatus 10. The control unit 900 may include at least one processor. Additionally, the control unit 900 may include a plurality of processors or a single integrated processor according to the function and role thereof.

In a specific example, the control unit 900 may control the first mapping table generation unit and the second mapping table generation unit to generate the first mapping table and the second mapping table. Furthermore, the control unit 900 may control all the components of the data security apparatus 10 so that it is checked whether data matching secondary encrypted data previously stored in the ledger of a blockchain is present in the second mapping table, the corresponding data is decrypted into primary encrypted data by using a decryption key mapped to the corresponding data as a pair if the corresponding data is present, and original data mapped to a value, matching the decrypted, primary encrypted data, as a pair is extracted from the first mapping table.

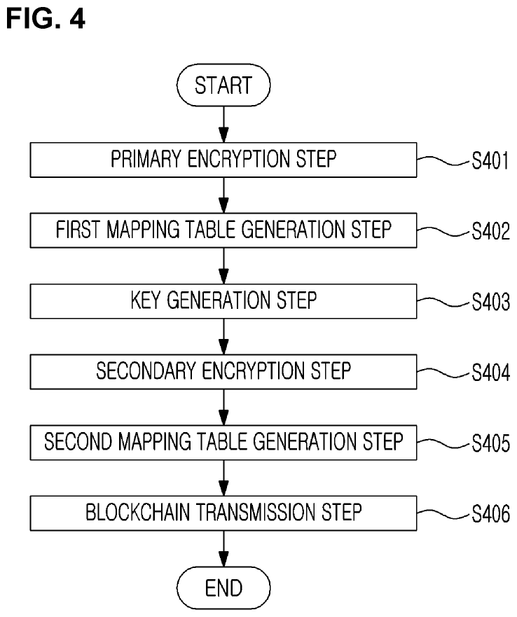

FIG. 4 is a flowchart schematically showing a data security method according to an embodiment of the present invention, and is a flowchart illustrating a process in which original data is encrypted and transmitted to a blockchain node.

The data security method according to the embodiment of the present invention will be described according to the flowchart shown in FIG. 4, and will be described with reference to the drawings shown in FIGS. 1 to 3 according to the sequence thereof for the sake of convenience.

1. Primary encryption step <S401>

At this step, the first encryption unit 100 may convert original data, previously stored in the original data storage apparatus 20, into primary encrypted data by encrypting it. For example, the first encryption unit 100 may encrypt the original data using various known encryption algorithms.

Meanwhile, before this step, there may be performed an original data reception step at which the communication unit 700 receives the original data from the original data storage apparatus 20.

2. First mapping table generation step <S402>

At this step, the first mapping table generation unit 200 may generate a first mapping table by mapping original data and primary encrypted data, obtained by encrypting the original data, to each other as a pair, and may store the generated first mapping table in a storage unit (not shown) inside the data security apparatus 10.

3. Key generation step <S403>

At this step, the encryption key generation unit 300 may generate an encryption key used to encrypt the primary encrypted data into secondary encrypted data, and the decryption key generation unit 400 may generate a decryption key used to decrypt the secondary encrypted data into the primary encrypted data. At this step, known key generation algorithms may be applied as the algorithm by which the encryption key is generated by the encryption key generation unit 300 and the algorithm by which the decryption key is generated by the decryption key generation unit 400.

4. Secondary encryption step <S404>

At this step, the second encryption unit 500 may encrypt the primary encrypted data into the secondary encrypted data using the encryption key. At this step, the second encryption unit 500 may perform encryption using the encryption key, but may re-encrypt the primary encrypted data into the secondary encrypted data using various known encryption algorithms.

5. Second mapping table generation step <S405>

At this step, the second mapping table generation unit 600 may generate a second mapping table by mapping the secondary encrypted data generated by the second encryption unit 500 to the decryption key used to convert the secondary encrypted data into the primary encrypted data as a pair, and may store the second mapping table in a storage unit. In other words, the secondary encrypted data and the decryption key mapped to each other by the second mapping table generation unit 600 have a close relationship with each other. The decryption key may be used to convert the secondary encrypted data, mapped to it, into the primary encrypted data.

6. Blockchain transmission step <S406>

At this step, the communication unit 700 may transmit the secondary encrypted data, generated at step S404, to the node 30 constituting a part of a blockchain network so that the secondary encrypted data is stored in the ledger of a blockchain. At this step, a computing apparatus connected to the blockchain distributed network may be applied as the node 30. Furthermore, the node 30 may include a memory module configured to store the ledger of the blockchain, and the memory module may be applied as a blockchain database configured to store all or part of the blocks of the overall blockchain.

Meanwhile, a data security method according to an embodiment may further indude a data deletion step. In this embodiment, the data deletion step may be performed after the blockchain transmission step.

According to a specific example, at the data deletion step, when the communication unit 700 of the data security apparatus 10 receives a request for the deletion of information associated with specific data stored in the ledger of the blockchain from the information stored in the first mapping table or second mapping table, the control unit 900 may perform control so that the data (the secondary encrypted data and the decryption key) stored in the second mapping table is deleted or so that the data (the original data and the primary encrypted data) stored in the first mapping table is deleted, or may perform control so that all of the data stored in the first mapping table and the data stored in the second mapping table.

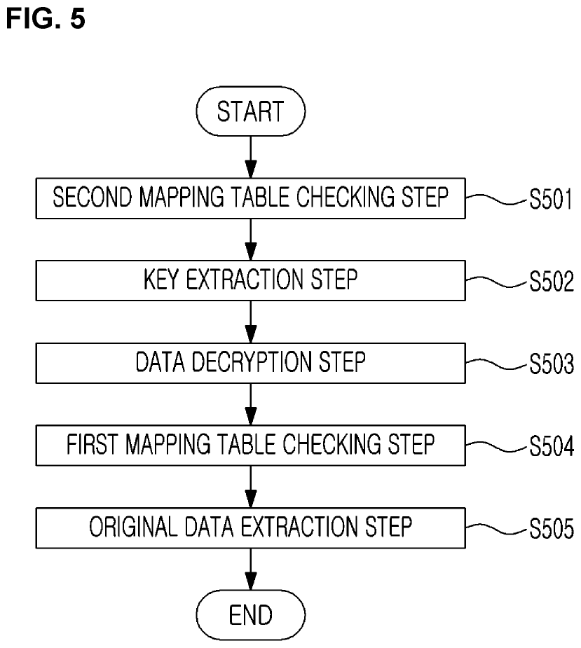

FIG. 5 is a flowchart schematically showing a data security method according to another embodiment of the present invention, and is a flowchart showing a method of decrypting secondary encrypted data matching secondary encrypted data previously stored in the ledger of a blockchain and checking original data. The data security method according to the other embodiment of the present invention will be described according to the flowchart shown in FIG. 5, and will be described with reference to the drawings shown in FIGS. 1 to 3 according to the sequence thereof for the sake of convenience.

1. Second mapping table checking step <S501>

At this step, the control unit 900 of the data security apparatus 10 may check whether data matching secondary encrypted data previously stored in the ledger of a blockchain is present in a second mapping table. In addition, before this step is performed, a first mapping table generated by mapping primary encrypted data obtained by encrypting data matching original data previously stored in the original data storage apparatus 20 to the original data as a pair, and a second mapping table generated by mapping secondary encrypted data obtained by encrypting the primary encrypted data to a decryption key used to decrypt the secondary encrypted data as a pair may be previously stored in the storage unit of the data security apparatus 10.

Meanwhile, before this step, there may be performed a request signal reception step at which the communication unit 700 receives a request signal requesting the deletion of data matching the secondary encrypted data previously stored in the ledger of the blockchain in the data security apparatus 10 or requesting the determination of whether there is present data matching the secondary encrypted data previously stored in the ledger of the blockchain.

2. Key extraction step <S502>

At this step, the control unit 900 may extract the decryption key, mapped to secondary encrypted data as a pair, from the second mapping table including corresponding secondary encrypted data matching the secondary encrypted data previously stored in the ledger of the blockchain. In other words, the secondary encrypted data and the decryption key have a close relationship with each other, and the decryption key may be used to convert the secondary encrypted data, mapped to the decryption key, into the primary encrypted data.

3. Data decryption step <S503>

At this step, the control unit 900 may control the decryption unit 800 to decrypt the second encrypted data, mapped to the decryption key as a pair, into the primary encrypted data using the decryption key extracted at step S502. At this step, the decryption unit 800 decrypts the data using the extracted decryption key, and may decrypt the secondary encrypted data into the primary encrypted data using various disclosed decryption algorithms.

4. First mapping table checking step <S504>

At this step, the control unit 900 may check whether a value matching the primary encrypted data decrypted at step S503 is present in the first mapping table through search.

5. Original data extraction step <S505>

At this step, the control unit 900 may extract original data, mapped to the specific value identified at step S504 (i.e., a value matching the primary encrypted data decrypted at step S503) as a pair, from the first mapping table.

Since the original data extracted at this step is data matching the original data previously stored in the original data storage apparatus 20, it may be possible to easily check the original content of the secondary encrypted data stored in the ledger of the blockchain without having to separately search the data of the original data storage apparatus 20.

The data security apparatus described above may be implemented as hardware components, software components, or a combination of hardware and software components. In addition, the components described in the above-described embodiments may be implemented using at least one general purpose computer or special purpose computer such as a processor, a controller, an arithmetic logic unit (ALU), a digital signal processor, a microcomputer, a microprocessor, or any other apparatus capable of executing and responding to commands.

In addition, the data security apparatus may execute an operating system and one or more software applications executed on the operating system, and may access, store, manipulate, process, and generate data in response to the execution of the software.

Although there are cases where a single component is described as being used for ease of understanding, it will be understood by those of ordinary skill in the art that a processing device may include a plurality of processing components or a plurality of types of processing components.

For example, the data security apparatus may indude a plurality of processors or one processor, and one controller. Altematively, other processing configurations, such as a parallel processor, may be possible. The software may include a computer program, code, instructions, or a combination of one or more of these, and may cause the data security apparatus to operate as desired, or may issue commands independently or collectively.

Each of the data security methods according to the various embodiments of the present invention may be implemented as a computer program, and code and code segments constituting the computer program may be easily inferred by computer programmers in the art. In addition, the computer program is stored in a computer-readable medium and is read and executed by a computer, thereby implementing the data security method. In this case, the information storage medium may include a magnetic storage medium, an optical storage medium, and a carrier wave medium. The computer program implementing the data security method according to an embodiment of the present invention may be stored and installed in a computing apparatus.

In other words, the various embodiments of the present invention may be each implemented as computer-readable code stored on a computer-readable storage medium. The computer-readable storage medium includes all types of storage devices that store data that can be read by a computer system. Examples of the computer-readable storage medium include ROM, RAM, CD-ROM, a magnetic tape, a floppy disk, and an optical data storage device. Furthermore, the computer-readable storage medium may be distributed over a computer system connected over a network and store and execute computer-readable code in a distributed manner.

The computer capable of reading a storage medium on which a program configured to execute the data security method according to each of the various embodiments of the present invention is stored includes not only general personal computers such as general desktop and notebook computers, but also mobile terminals such as a smartphone, a tablet PC, and a personal digital assistant (PDA), and a mobile communication terminal, and should be interpreted as any device capable of computing.

Although there are cases where the above-described single component has been described as being used for ease of understanding, it will be understood by those of ordinary skill in the art that a processing device may include a plurality of processing components or a plurality of types of processing components.

As described above, according to the various embodiments of the present invention, original data is encrypted twice and secondary encrypted data other than the original data is stored in the ledger of a blockchain, so that the effect of ensuring the security of stored data is achieved even when data related to personal information is stored in the blockchain.

In addition, according to the various embodiments of the present invention, the original data extracted from the first mapping table is the same data as the original data previously stored in the original data storage apparatus 20. Accordingly, it may be possible to easily check the original content of secondary encrypted data stored in the ledger of a blockchain without directly searching the data of the original data storage apparatus 20.

Furthermore, according to the various embodiments of the present invention, control is performed such that the original data and the primary encrypted data mapped to each other as a pair in the first mapping table are deleted, the secondary encrypted data and the decryption key mapped to each other as a pair in the secondary mapping table are deleted, or all of the data stored in the first mapping table and the data stored in the second mapping table are deleted. Accordingly, access to the original data through the secondary encrypted data may be blocked without directly deleting or changing the secondary encrypted data stored in the blockchain.

Therefore, an effect is achieved in that it may be possible to implement a technology that does not violate the GDPR that aims to guarantee the basic rights of individuals while making use of the advantages of blockchain technology.

In addition, when the various embodiments of the present invention are used, the present invention may be applied to the MyData service that stores and distributes sensitive data such as personal medical information and financial information. At the time when the base of the MyData service expands, it may be possible to develop an operation and management solution for an enterprise blockchain (a corporate blockchain) with the functions installed therein. Additionally, based on these, it may also be possible to develop a solution that keeps track of an individual's various behavioral histories with blockchain technology.

As described above, the detailed description of the present invention has been made using the embodiments taken with reference to the accompanying drawings. However, since the above-described embodiments have been described with reference to the preferred examples of the present invention, it should not be understood that the present invention is limited to the above embodiments, but the scope of the present invention should be understood based on the following claims and equivalents thereto.

### DESCRIPTION OF REFERENCE SYMBOLS

10: data security apparatus

100: first encryption unit

200: first mapping table generation unit

300: encryption key generation unit

400: decryption key generation unit

500: second encryption unit

600: second mapping table generation unit

700: communication unit

800: decryption unit

900: control unit

20: original data storage apparatus

30: blockchain node

1. A method for blockchain-based data security, the method being performed by a data security apparatus, the method comprising:
a primary encryption step of converting original data, previously stored in an original data storage apparatus, into primary encrypted data by encrypting the original data;
a secondary encryption step of converting the primary encrypted data into secondary encrypted data by encrypting the primary encrypted data; and
a blockchain transmission step of transmitting the secondary encrypted data to a node constituting a part of a blockchain network so that the secondary encrypted data is stored in a ledger of a blockchain.

2. The method of claim 1, further comprising a key generation step of generating an encryption key used to encrypt the primary encrypted data into the secondary encrypted data and generating a decryption key used to decrypt the secondary encrypted data into the primary encrypted data.

3. The method of claim 1, further comprising a first mapping table generation step of generating a first mapping table by mapping the original data to the primary encrypted data as a pair.

4. The method of claim 2, further comprising a second mapping table generation step of generating a second mapping table by mapping the secondary encrypted data to the decryption key as a pair.

5. A method for blockchain-based data security, the method being performed by a data security apparatus including a first mapping table generated by mapping primary encrypted data obtained by encrypting original data previously stored in an original data storage apparatus to the original data as a pair, and a second mapping table generated by mapping secondary encrypted data obtained by encrypting the primary encrypted data to a decryption key used to decrypt the secondary encrypted data as a pair, the method comprising:
a second mapping table checking step of checking whether data matching secondary encrypted data previously stored in a ledger of a blockchain is present in the second mapping table;
a key extraction step of extracting a decryption key mapped to the data as a pair from the second mapping table; and
a data decryption step of decrypting the data into primary encrypted data using the extracted decryption key.

6. The method of claim 5, further comprising a first mapping table checking step of checking whether a value matching the decrypted, primary encrypted data is present in the first mapping table.

7. The method of claim 6, further comprising an original data extraction step of extracting original data mapped to the value as a pair from the first mapping table.

8. An apparatus for blockchain-based data security, the apparatus comprising:
a first encryption unit configured to encrypt original data previously stored in an original data storage apparatus;
a first mapping table generation unit configured to generate a first mapping table by mapping primary encrypted data, generated by the first encryption unit, to the original data as a pair;
an encryption key generation unit configured to generate an encryption key used to encrypt the primary encrypted data into secondary encrypted data;
a decryption key generation unit configured to generate a decryption key used to decrypt the secondary encrypted data into the primary encrypted data;
a second encryption unit configured to encrypt the primary encrypted data into the secondary encrypted data using the encryption key;
a second mapping table generation unit configured to generate a second mapping table by mapping the secondary encrypted data, generated by the second encryption unit, to the decryption key as a pair; and
a communication unit configured to transmit the secondary encrypted data to a node constituting a part of a blockchain network so that the secondary encrypted data is stored in a ledger of a blockchain.

9. The apparatus of claim 8, further comprising:
a control unit configured to control the generation of the first mapping table and the second mapping table; and
a decryption unit configured to decrypt the secondary encrypted data into the primary encrypted data using the decryption key;
wherein the control unit performs control so that it is checked whether data matching the secondary encrypted data previously stored in the ledger of the blockchain is present in the second mapping table, the data is decrypted into primary encrypted data using a decryption key mapped to the data as a pair if the data is present, and original data mapped to a value matching the decrypted primary encrypted data as a pair is extracted from the first mapping table.

10. A computer-readable storage medium having stored thereon a program for performing the method set forth in claim 1.

11. A computer-readable storage medium having stored thereon a program for performing the method set forth in claim 2.

12. A computer-readable storage medium having stored thereon a program for performing the method set forth in claim 3.

13. A computer-readable storage medium having stored thereon a program for performing the method set forth in claim 4.

14. A computer-readable storage medium having stored thereon a program for performing the method set forth in claim 5.

15. A computer-readable storage medium having stored thereon a program for performing the method set forth in claim 6.

16. A computer-readable storage medium having stored thereon a program for performing the method set forth in claim 7.
